(19) United States
(12) Patent Application Publication
(10) Pub. No.: US 2011/0279472 A1
(43) Pub. Date: Nov. 17, 2011

(54) DISPLAY ARRANGEMENT AND METHOD OF DISPLAYING INFORMATION

(75) Inventors: David Lu, Taipei City (TW); Norman Wu, Taipei City (TW)

(73) Assignee: Sony Ericsson Mobile Communications AB, Lund (SE)

(21) Appl. No.: 12/779,953

(22) Filed: May 14, 2010

(51) Int. Cl. G09G 5/02

(52) U.S. Cl. 345/589

(57) ABSTRACT

The present invention relates to a method and a display device comprising a surface for displaying information. The information has at least one of a color hue or contrast for a content and at least one of a color hue or contrast for a background of the content. The display device is configured to relate said at least one of a background color hue or contrast and said at least one of a content color hue or contrast in such a way that said content has limited visibility observed from an angle deviating from a frontal view angle.

### TECHNICAL FIELD

This invention relates generally to information security. More particularly, this invention relates to method and arrangement for enabling a secure, private display of visual content on various display screens.

### BACKGROUND

Display devices, for example for computers or mobile phones, are often vulnerable to sneaky observation by individuals seeking to gain confidential information presented on the display. This may be intentional or unintentional. Even a casual glance at a display may yield confidential information that should not be disclosed to unauthorized individuals.

Such sensitive information includes records that are protected, e.g. medical or financial records, proprietary corporate information, classified government information, or personal information. Password security and data encryption programs do not provide any protection against persons simply reading displayed confidential content over an authorized user's shoulder

Use of mobile phones and portable computers with ability to access, e.g. e-mails and text messages, allow the user to access information almost anywhere, also in public places. This information may be sensitive and private. In public spaces, it is difficult to achieve privacy of information on conventional display systems. On airplanes, in coffee shops, in office environments, etc., important private information is subject to unintentional or intentional disclosure.

The privacy systems available today provide only limited protection against information disclosure. One may use plastic shields mounted over and around a display device to narrow the view range. Moreover, there is no guarantee that the user will use these systems properly or at all.

### SUMMARY

Consequently, there is a need for a display arrangement allowing secure view of the content. More particularly, the present invention addresses the problem of displaying data privately and securely by displaying data legibly within a limited view filed of a reader and illegibly outside of the reader's the limited view field.

For these reasons a display device comprising a surface for displaying information. The information comprises at least one of a color hue or contrast for a content and at least one of a color hue or contrast for a background. The display device is configured to relate the at least one of a background color hue or contrast and the at least one of a content color hue or contrast in such a way that the content has limited visibility observed from an angle deviating from a frontal view angle. The display device may further comprise a controller for providing the at least one of color hues or contrasts based on similarity value. The display device may further comprise a controller for providing the at least color hues or contrasts based on a color or contrast scheme table. The display device may further comprise means for controlling the side view angle. The display device may have an operational mode with no limited visibility.

The invention also relates to a method of securely providing information on a display. The information comprises a content and a background. The method comprises relating at least one of a color hue or contrast for the content and at least one of a color hue or contrast for the background on the display such that the content has limited visibility observed from an angle deviating from a frontal view angle.

The invention also relates to a device comprising a display and a display controller. The display comprises a surface for displaying information, the information having at least one of a color hue or contrast for a content and at least one of a color hue or contrast for a background. The display controller is configured to relate the at least one of a color hue or contrast for the content and at least one of a color hue or contrast for the background in such a way that the content has limited visibility observed from an angle deviating from a frontal view angle. The relating of the at least content color hue or contrast and the at least background color hue or contrast in such a way that the content has limited visibility observed from an angle deviating from a frontal view angle is provided by a user, an application and/or a message.

The invention also relates to a computer program product comprising computer-executable instructions embodied in a computer-readable medium for performing steps for securely providing information on a display. The steps comprise relating at least one of a color hue or contrast for a content and at least one of a color hue or contrast for a background of the content on the display such that the content has limited visibility observed from an angle deviating from a frontal view angle.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B are schematics of a display according to example embodiments;

FIGS. 2A and 2B are schematics of a display according to example embodiments;

FIG. 3 a block diagram of a display apparatus according to example embodiments;

FIG. 4 is a flow diagram of example operational steps which may be performed by the apparatus of FIG. 3 according to example embodiments; and

FIG. 5 is a mobile device according to example embodiments.

### DETAILED DESCRIPTION

In the following the invention is described with reference to a display used in a device, especially a mobile phone. A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

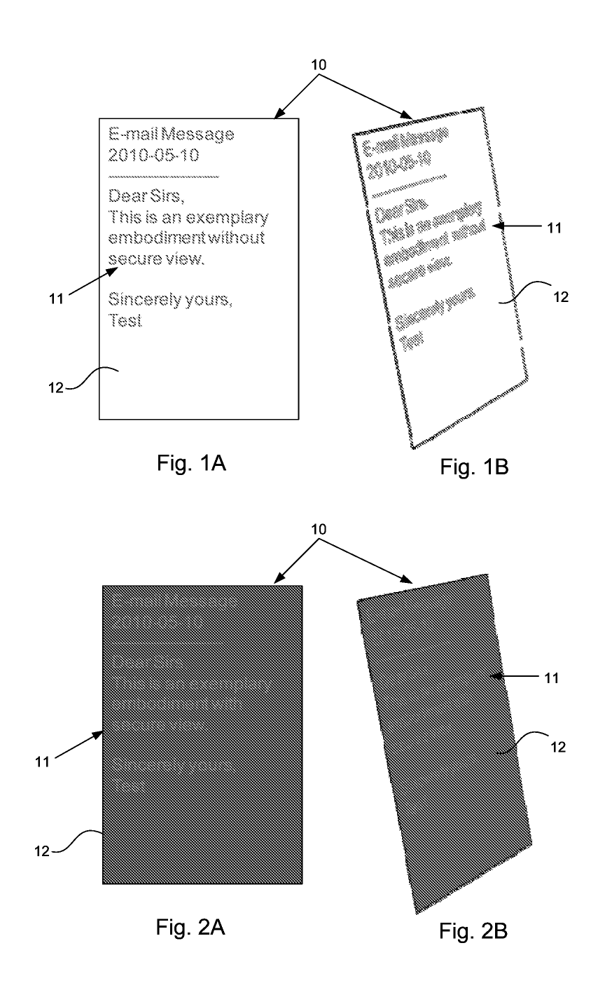

FIGS. 1A and 1B and FIGS. 2A and 2B illustrate appearance of a display employing the teachings of the present invention. FIGS. 1A and 2A are frontal views and FIGS. 1B and 2B are side views in perspective.

In FIGS. 1A and 1B a display 10 is illustrated displaying, in a normal mode of operation, content 11 on the surface 12 of the display. The content may be any type of information in form of characters, figures, images or combinations thereof.

As it is evident from the drawings, the content is legible in both frontal and side view cases.

In FIGS. 2A and 2B the display 10 is illustrated displaying, in a “secure view” mode of operation, content 11 on the surface 12 of the display. In this case, the content is legible in the frontal view and illegible in side view.

This is achieved by changing the colors of the background and characters (content) to similar color hue with different saturation.

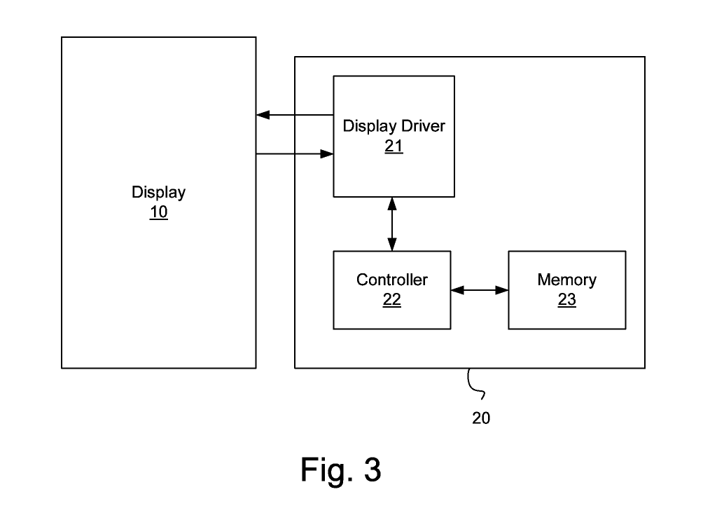

FIG. 3 illustrates a display 10 including a control arrangement 20 for carrying out the invention. The control arrangement according to this embodiment comprises a display driver 21, a controller or micro-processor 22 and a memory 23.

When the display 10 is operating in the “secure view” mode, the controller 22 controls the display driver 21. The memory 23 may store data on background and character colors. For example, if background color is light gray, the character color may be chosen to darker or lighter gray with an amount of intensity, i.e. Cc=Bc+/−n %, wherein Cc is character color, Bc is background color and n is a parameter for altering intensity/hue based on Bc. “+/−” means that the color hue may be set to higher or lower hue. The percentage sign is given as example and different types of intensity relations may be applied. The above function may also be: Bc=Cc+/−n %

In another embodiment the memory may store a color scheme table, in which different colors for the background are related to character colors or vice verse, providing legibility from the frontal view and illegibility from the side view.

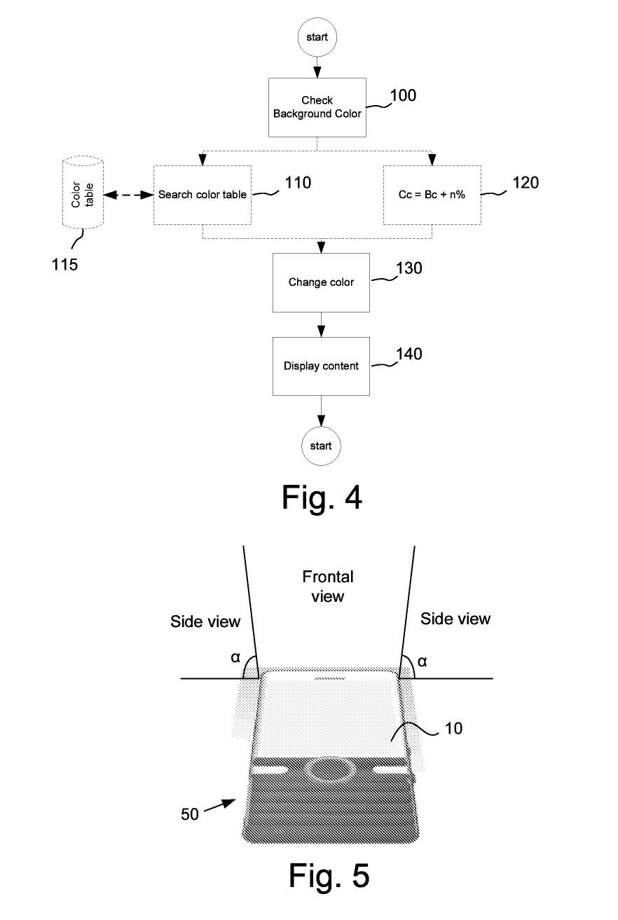

The flow diagram of FIG. 4 illustrates the steps according to one exemplary method of the invention. When the controller receives instruction for displaying in “secure view”, in step 100 the controller check for background color, e.g. in an image memory. Depending on the design, the controller may set the character color either by looking up 110 in a color scheme table 115 or computing 120 a character color a combination thereof. When the character color is determined the color is set 130 and the content is displayed 140.

As mentioned earlier, the controller may start with character color and set the background color.

Other functions for determining the colors may be applied.

The “secure view” functionality may be set by the user. However, the device may be programmed to set the functionality automatically, e.g. based on the message permissions, applications running or position.

The message may be tagged by the sender with a security tag, which forces the device to alter background and character color.

Applications such as text/multimedia, E-mail, different types of reader (PDF, .DOC, .XLS, etc.) may set device to operate in secure view mode.

The position of the device may be determined by a positioning application and if (predetermined or real-time determined) that the current position is not secure, e.g. public, the device may change to secure view mode.

FIG. 5 illustrates a mobile phone 50 comprising a display 10 with secure view functionality according to the present invention. The side view as mentioned earlier in the application is illustrated to comprises a view of the display with and angle α of 0 (zero) to 90 degrees, preferably 0 to 60 degrees. In one embodiment, the user may be able set the frontal and side view angle (α).

In one embodiment the contrast of the background and information may be adjusted to achieve same result. It should be noted that different angles may have different contrasts and make the visual result different. In same way as described earlier the contrasts may be based on similarity value or chosen from a contrast scheme table.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

What is claimed is:

1. A display device comprising:
a surface for displaying information, said information comprising at least one of a color hue or contrast for a content and at least one of a color hue or contrast for a background, wherein said display device is configured to relate said at least one of a background color hue or contrast and said at least one of a content color hue or contrast in such a way that said content has limited visibility observed from an angle deviating from a frontal view angle.

2. The display device of claim 1, further comprising a controller for providing said at least one of color hues or contrasts based on similarity value.

3. The display device of claim 1, further comprising a controller for providing said at least color hues or contrasts based on a color or contrast scheme table.

4. The display device of claim 1, further comprising a controller for controlling said side view angle.

5. The display device of claim 1, comprising an operational mode with no limited visibility.

6. A method of securely providing information on a display, said information comprising a content and a background, the method comprising:
relating at least one of a color hue or contrast for the content and at least one of a color hue or contrast for the background on said display such that said content has limited visibility observed from an angle deviating from a frontal view angle.

7. A device comprising a display and a display controller, said display comprising a surface for displaying information, said information having at least one of a color hue or contrast for a content and at least one of a color hue or contrast for a background, wherein said display controller is configured to relate said at least one of a color hue or contrast for the content and at least one of a color hue or contrast for the background in such a way that said content has limited visibility observed from an angle deviating from a frontal view angle.

8. The device of claim 7, wherein said relating of said at least content color hue or contrast and said at least background color hue or contrast in such a way that said content has limited visibility observed from an angle deviating from a frontal view angle is provided by a user.

9. The device of claim 7, wherein said relating of said at least content color hue or contrast and said at least background color hue or contrast in such a way that said content has limited visibility observed from an angle deviating from a frontal view angle is provided by an application.

10. The device of claim 7, wherein said relating of said at least content color hue or contrast and said at least background color hue or contrast in such a way that said content has limited visibility observed from an angle deviating from a frontal view angle is provided by a message.

11. A computer-readable medium comprising computer-executable instructions for performing a method for securely providing information on a display, the method comprising:
relating at least one of a color hue or contrast for a content and at least one of a color hue or contrast for a background of said content on said display such that said content has limited visibility observed from an angle deviating from a frontal view angle.
